(19) United States
(12) Patent Application Publication
(10) Pub. No.: US 2026/0292574 A1
(43) Pub. Date: Sep. 24, 2026

(54) MEASUREMENT AND REPORTING ENHANCEMENT FOR COHERENT JOINT TRANSMISSION IN 5G AND 6G NETWORKS

(71) Applicant: Intel Corporation, Santa Clara, CA (US)

(72) Inventors: Bishwarup Mondal, San Ramon, CA (US); Avik Sengupta, San Jose, CA (US); Viktor Sergeev, Lucan, Dublin (IE); Gang Xiong, Beaverton, OR (US)

(21) Appl. No.: 19/484,609

(22) PCT Filed: Nov. 11, 2024
(86) PCT No.: PCT/US2024/055368

§ 371 Date: Nov. 14, 2025

Related U.S. Application Data
(60) Provisional application No. 63/627,515, filed on Jan. 31, 2024.
(60) Provisional application No. 63/571,280, filed on Mar. 28, 2024.

(51) Int. Cl. H04W 24/10; H04B 7/024; H04B 7/06; H04B 17/11; H04L 5/00

(52) U.S. Cl. CPC H04W 24/10; H04B 7/024; H04B 7/0626; H04B 17/11; H04L 5/0035

(57) ABSTRACT

A user equipment (UE) in a 5G NR network is configured for reference signal measurement and reporting for coherent joint transmission (CJT) from two or more transmission-reception points (TRPs). The UE may decode RRC signalling with reference signal resource set configuration information for inter-TRP calibration measurements of more than one CSI-RS resource set, reporting configuration information for reporting the inter-TRP calibration measurements for the one or more than one CSI-RS resource sets, and one or more trigger states. Each trigger state may comprise a list of associated reporting configurations indicating resource set IDs of the configured CSI-RS resource sets. The UE may decode a DCI format having a CSI request field triggering one of the one or more trigger states for the inter-TRP calibration measurement and the reporting. In response to the DCI format, the UE may generate a report for transmission to a gNB that includes the inter-TRP calibration measurements and the resource set ID(s) of the CSI-RS resource sets associated with the inter-TRP calibration measurements.

### PRIORITY CLAIM

This application claims priority to U.S. Provisional Patent Application Ser. No. 63/627,515, filed Jan. 31, 2024 [reference number AF8976-Z], and U.S. Provisional Patent Application Ser. No. 63/571,280 filed Mar. 28, 2024 [reference number AG 0345-Z], which are incorporated herein by reference in its entireties.

### TECHNICAL FIELD

Embodiments pertain to wireless communications. Some embodiments relate to fifth-generation new radio (5G-NR) networks. Some embodiments relate to sixth-generation (6G) networks.

### BACKGROUND

5G NR networks use Coherent Joint Transmission (CJT). CJT is an advanced multi-point transmission technique designed to enhance network performance and user experience. Implementing CJT across a large network presents several key challenges. These challenges include synchronization (i.e., precise timing synchronization between multiple transmission points is crucial for CJT). These challenges also include Channel State Information (CSI) Accuracy (e.g., effective CJT relies on accurate and up-to-date CSI). In a large, dynamic network environment, maintaining precise CSI for numerous users and transmission points is challenging and can impact CJT performance. Thus, there are general needs for improved 5G and 6G network communications using CJT.

### BRIEF DESCRIPTION OF THE DRAWINGS

FIG. 1 illustrates Coherent Joint Transmission (CJT) communications between a user equipment (UE) and multiple transmission-reception points (TRPs) in accordance with some embodiments;

FIG. 2 illustrates the use of a reference resource set for inter-TRP calibration measurements in accordance with some embodiments; and

FIG. 3 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

5G NR networks use Coherent Joint Transmission (CJT). CJT is an advanced multi-point transmission technique designed to enhance network performance and user experience. It falls under the broader category of Coordinated Multi-Point (COMP) transmission and reception strategies. In CJT, multiple base stations or transmission points simultaneously transmit data to a single user equipment (UE) in a coordinated manner. This coordination is achieved through precise synchronization and joint processing of signals at the transmitter side. CJT may include signal Combination in which the signals from multiple transmission points are combined coherently at the UE, resulting in improved signal quality and strength. CJT may also result in interference mitigation by coordinating transmissions to effectively reduce inter-cell interference, which is particularly beneficial in dense network deployments. CJT may improve spectral Efficiency by allowing for more efficient use of available spectrum by enabling multiple transmission points to serve the same UE on the same time-frequency resources. CJT may also provide coverage enhancement particularly for users at cell edges or in areas with poor coverage and therefore effectively extending the effective range of the network. CJT may also provide for an increase in capacity through improved signal quality and reduced interference leading to higher data rates and increased network capacity.

While CJT offers significant advantages, its effectiveness can be influenced by factors such as channel conditions, network topology, and the accuracy of channel state information. As 5G networks continue to evolve, CJT is expected to play a crucial role in meeting the increasing demands for high-speed, low-latency, and reliable wireless communications.

Standardization efforts for Coherent Joint Transmission (CJT) in 5G networks have been primarily driven by the 3rd Generation Partnership Project (3GPP), the main standardization body for mobile telecommunications. These efforts have been ongoing since the early stages of 5G development and continue to evolve. These standardization efforts aim to ensure interoperability, scalability, and efficient implementation of CJT across different vendor equipment and network deployments in 5G ecosystems.

Implementing Coherent Joint Transmission (CJT) across a large 5G network presents several key challenges. These challenges include synchronization (i.e., precise timing synchronization between multiple transmission points is crucial for CJT). In a large network, maintaining this synchronization across numerous base stations can be technically demanding and resource-intensive. These challenges also include Channel State Information (CSI) Accuracy (e.g., effective CJT relies on accurate and up-to-date CSI). In a large, dynamic network environment, maintaining precise CSI for numerous users and transmission points is challenging and can impact CJT performance.

Embodiments disclosed herein relate to inter-transmission-reception point (inter-TRP) calibration for coherent-joint transmission (CJT). Some embodiments disclosed herein relate to inter-TRP calibration measurement and reporting for CJT. Some embodiments are directed to measurement and reporting enhancements for coherent joint transmission in 5G and 6G networks.

For coherent joint transmission (CJT), more than one transmit and receive points (TRP) transmit the packet simultaneously to the UE. For CJT, network may need to obtain knowledge about the detailed channels to the device from the TRPs involved in the joint transmission and selects transmission weights accordingly. In general, CJT offers downlink spectral efficiency and coverage gain.

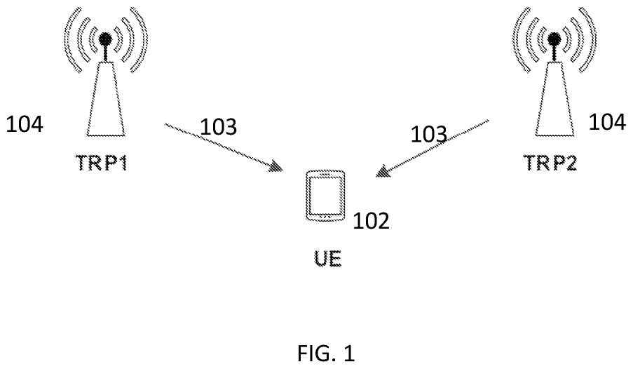

FIG. 1 illustrates CJT communication between a user equipment (UE) and multiple transmission-reception points (TRPs) in accordance with some embodiments. In a CJT, signals from multiple transmission points 104 are combined at the user equipment (UE) 102. In CJT, the signals 103 are combined coherently (i.e., synchronized in phase and timing to constructively interfere with each other). This coherent combination is achieved through precise coordination and synchronization between the transmitting TRPs. The transmitted signals are frequency compensated, time-aligned and/or phase-aligned so that when they reach the UE, they add up constructively, reinforcing each other to create a stronger, higher-quality signal. This coherent combination is in contrast to non-coherent combining techniques, where signals might be combined based on their power levels without considering their phase relationships. The coherent approach in CJT allows for more efficient signal combination, potentially leading to better signal quality, higher data rates, and improved coverage, especially for users at cell edges or in areas with challenging radio conditions.

In Rel-18 of the 3GPP standards for 5G NR, Type-II channel state information (CSI) has been enhanced to accommodate CJT assuming ideal synchronization and backhaul. Scenarios such as inter-site CJT and a base station equipped with distributed remote radio heads (RRHs) require additional delay and phase/frequency calibration. For TDD, additional inter-TRP DL/UL calibration across TRPs is also beneficial to ensure proper DL/UL reciprocity holds. As the UE possesses more knowledge on DL channel condition in both FDD and TDD, the need for inter-TRP calibration reporting measured from CSI-RS is evident not only to expand the deployment scenarios, but also to offer additional robustness to CJT operation. To improve the performance of CJT under non-ideal synchronization and backhaul, UE reporting enhancement may be considered, by considering inter-TRP timing difference and frequency/phase offset measurement and reporting.

Embodiments disclosed herein are directed to measurement and reporting enhancement for coherent joint transmission (CJT). In these embodiments, measurements are performed on inter-TRP timing difference and frequency/phase offset for CJT. In these embodiments, reporting is performed on inter-TRP timing difference and frequency/phase offset for CJT.

User equipment (UE) 102 may be configured for operating in a 5G NR network. The UE 102 may be configured for reference signal measurement and reporting for coherent joint transmission (CJT) from two or more transmission-reception points (TRPs) 104. The UE may decode RRC signalling with reference signal resource set configuration information for inter-TRP calibration measurements of more than one CSI-RS resource set, reporting configuration information for reporting the inter-TRP calibration measurements for the one or more than one CSI-RS resource sets, and one or more trigger states. Each trigger state may comprise a list of associated reporting configurations indicating resource set ID(s) of the configured CSI-RS resource sets. The UE may decode a DCI format having a CSI request field triggering one of the one or more trigger states for the inter-TRP calibration measurement and the reporting. In response to the DCI format, the UE may generate a report for transmission to a gNB that includes the inter-TRP calibration measurements and the resource set ID(s) of the CSI-RS resource sets associated with the inter-TRP calibration measurements.

### Measurement on Inter-TRP Timing Difference and Frequency/Phase Offset for CJT

As mentioned above, scenarios such as inter-site CJT and a base station equipped with distributed remote radio heads (RRHs) require additional delay and phase/frequency calibration. For TDD, additional inter-TRP DL/UL calibration across TRPs is also beneficial to ensure proper DL/UL reciprocity holds. As the UE possesses more knowledge on DL channel condition in both FDD and TDD, the need for inter-TRP calibration reporting measured from CSI-RS is evident not only to expand the deployment scenarios, but also to offer additional robustness to CJT operation. To improve the performance of CJT under non-ideal synchronization and backhaul, UE reporting enhancement may be considered, by considering inter-TRP timing difference, and frequency and phase offset measurement and reporting.

In the following embodiments, inter-TRP calibration measurement and reporting may include inter-TRP timing difference or time misalignment, and frequency and/or phase offset measurement and reporting. Embodiments of measurement on inter-TRP timing difference and frequency/phase offset for CJT operation are provided. In one embodiment, one or more than one CSI-RS resource sets or TRS resource sets may be configured for inter-TRP calibration measurement.

Further, when more than one CSI-RS resource sets or TRS resource sets are configured for inter-TRP calibration measurement, the number of CSI-RS resources or TRS resources in the CSI-RS resource sets or TRS resource sets is same. In addition, same resource type configurations, including periodic, semi-persistent and aperiodic CSI-RS resource or TRS resources for different CSI-RS resource sets or TRS resource sets are configured for inter-TRP calibration measurement. UE may assume that CSI-RS resources or TRS resources in different CSI-RS resource sets or TRS resource sets are configured with same bandwidth and subcarrier locations.

Further, UE may assume that same powerControl Offset and/or powerControlOffsetSS are configured for CSI-RS resources or TRS resources in different CSI-RS resource sets or TRS resource sets, respectively. In addition, UE may assume same periodicity for CSI-RS resources or TRS resources in different CSI-RS resource sets or TRS resource sets for inter-TRP calibration measurement, respectively.

In another embodiment, when more than one antenna ports are configured for CSI-RS resources in a CSI-RS resource sets, same antenna port for the CSI-RS resources in all the resource sets is assumed for inter-TRP calibration measurement.

In another embodiment, gNB may indicate a CSI-RS resource set ID or TRS resource set ID as a reference for inter-TRP calibration measurement. This may apply for the case when more than one CSI-RS resource sets or TRS resource sets are configured for inter-TRP calibration measurement. In this case, UE may use the indicated CSI-RS resource set or TRS resource set as a reference to determine the inter-TRP timing, frequency and phase offset between the reference TRP and another TRP.

In another embodiment, when one CSI-RS resource set or TRS resource set is configured, gNB may indicate one CSI-RS resource ID or one TRS resource ID as reference for inter-TRP calibration measurement.

In another embodiment, gNB may indicate one or more CSI-RS resource IDs or TRS resource IDs and/or corresponding CSI-RS resource set ID or TRS resource set ID as reference for inter-TRP calibration measurement.

In another embodiment, one CSI-RS resource or TRS resource and/or corresponding CSI-RS resource set or TRS resource set may be defined as a reference for inter-TRP calibration measurement. In one example, CSI-RS resource or TRS resource and/or corresponding CSI-RS resource set or TRS resource set with smallest ID value may be defined as a reference.

In another embodiment, when TRS is configured for inter-TRP calibration measurements, configured TRS resource or TRS resource set may be linked to the CSI-RS resource or CSI-RS resource set that is used for CSI measurement for CJT, respectively. In one example, the TRS resource ID may be associated with CSI-RS resource ID, and/or the TRS resource set ID may be associated with CSI-RS resource set ID for inter-TRP calibration measurement.

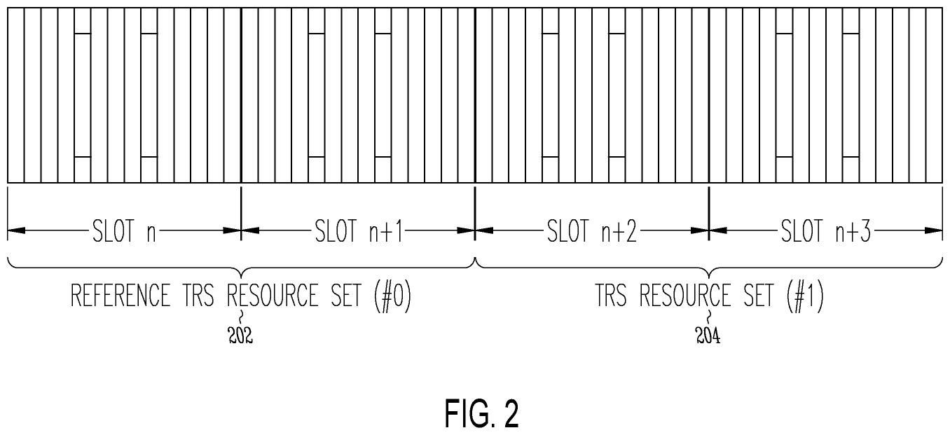

FIG. 2 illustrates the use of a reference resource set for inter-TRP calibration measurements in accordance with some embodiments. FIG. 2 illustrates one example of reference TRS resource set for inter-TRP calibration measurement. In FIG. 2, TRS resource set #0 is indicated or configured as a reference resource set 202. UE may determine the inter-TRP timing difference between the reference resource set and another resource set 204 (e.g., TRS resource set #1).

In another embodiment, the inter-TRP timing difference can be defined as the DL relative timing difference between the Transmission Point (TP) j and the reference TP i, which can be given by T_{subframeRxj}−T_{SubframeRxi}, where T_{SubframeRxj} is the time when the UE receives the start of one subframe from TP j, and T_{SubframeRxi} is the time when the UE receives the corresponding start of one subframe from TP I that is closest in time to the subframe received from TP j. In one embodiment the reported value of T_{SubframeRxj}−T_{SubframeRxi} is the estimated time difference of arrival of signals of TRP j with reference to TRP i. In one embodiment the time difference of arrival of one or more TRPs is reported with respect to the receive (downlink) timing of a reference TRP. A reference TRP or a reference downlink timing is defined in the specifications or indicated by the gNB.

In some embodiments, multiple CSI-RS resources or TRS resources can be used to determine the start of one subframe from a TP. Further, for frequency range 1, the reference point for the inter-TRP timing difference shall be the antenna connector of the UE. For frequency range 2, the reference point for the inter-TRP timing difference shall be the antenna of the UE.

In another embodiment, for inter-TRP timing difference measurement, the reporting range may be defined as [−N·T_{c}, N·T_{c}] with resolution step of 2^{K}·T_{c}, where T_{c} is the minimum timing duration as defined in Section 4.1 in TS 38.211 [1], and N is an integer that is predefined in the specification or configured by higher layers via NR remaining minimum system information (RMSI), NR other system information (OSI) or dedicated radio resource control (RRC) signalling, K is an integer, which can be predefined in the specification or configured by RMSI, OSI, or RRC signalling. For instance, K=3, 4 or 5.

In another embodiment, K may be determined in accordance with the subcarrier spacing of the active DL BWP or for the transmission of CSI-RS or TRS for inter-TRP calibration measurement.

In another embodiment, for inter-TRP timing difference measurement, the reporting range may be defined as [−N·Tₛ, N·Tₛ] with resolution step of 2^{K}·Tₛ, where Tₛ is the timing duration as Tₛ=1/(30·10³·4096), and Nis an integer that is predefined in the specification or configured by higher layers via RMSI, OSI, or RRC signalling, K is an integer, which can be predefined in the specification or configured by RMSI, OSI, or RRC signalling. For instance, K=0 or 1.

In some embodiments, gNB may indicate a range of inter-TRP timing difference for assistance to the UE. In particular, the maximum and/or minimum inter-TRP timing difference may be configured by higher layers for inter-TRP timing difference measurement. This may also apply to the inter-TRP frequency offset.

In another embodiment, for inter-TRP frequency offset measurement, the reporting range may be defined as [″Δfₘₐₓ, Δfₘₐₓ] with resolution step of Δfₛₜₑₚ, where Δfₘₐₓ and Δfₛₜₑₚ can be predefined in the specification or configured by higher layers via RMSI, OSI, or RRC signalling. In one embodiment the reported value of frequency offset for each TRP is with respect to the center frequency of the measurement channel. In one embodiment the reported value of the frequency offset is with respect to the estimated frequency offset of a reference TRP. A reference TRP is defined or indicated by a gNB.

In another embodiment, Δfₘₐₓ and/or Δfₛₜₑₚ may be determined in accordance with the carrier frequency for inter-TRP calibration measurement.

In another embodiment, for inter-TRP phase offset measurement, the reported value can be defined as k, where k={0, 1, . . . , Nₚ−1}, and Nₚ is a predetermined in the specification or configured by higher layers via RMSI, OSI, or RRC signalling. In one example, Nₚ=16. In this case, the corresponding phase value can be determined as exp(j2πk/Nₚ) In one embodiment the inter-TRP phase offset that is reported corresponding to a TRP j is a value that is applicable to all the CSI-RS ports (downlink Tx ports) associated with TRP j for one or more layers. In one embodiment the inter-TRP phase offset that is reported corresponding to a TRP j is determined with respect to TRP i and all the CSI-RS ports (downlink Tx ports) associated with TRP i. In one embodiment a reported inter-TRP phase offset is limited to certain sub-bands and/or limited to certain transmission ranks. This may also apply for the inter-TRP frequency offset.

In one embodiment, for inter-TRP timing difference and/or inter-TRP frequency offset and/or inter-TRP phase offset, if receiver diversity is in use by the UE, the reported value shall be no lower than the minimum and no higher than the maximum measured values across the receiver branches. In one embodiment the reported value shall be no lower than the minimum and no higher than the maximum measured values across the receive spatial filters or across the receive spatial filters associated with the same UE capability value set.

In one embodiment, for inter-TRP timing difference and/or inter-TRP frequency offset and/or inter-TRP phase offset, if CSI-RS resource set(s) is(are) configured for the measurements, the reported value shall be no lower than the minimum and no higher than the maximum measured values across the CSI-RS ports of CSI-RS resources or CSI-RS resource sets corresponding to each TRP.

In one embodiment, for inter-TRP timing difference and/or inter-TRP frequency offset and/or inter-TRP phase offset, if CSI-RS resource set(s) is(are) configured for the measurements, the reported value is determined as an average value over measured values across the CSI-RS ports of CSI-RS resources or CSI-RS resource sets corresponding to each TRP. Further, the average corresponds to the linear average.

### Reporting on Inter-TRP Timing Difference and Frequency/Phase Offset for CJT

Embodiments of reporting on inter-TRP timing difference and frequency/phase offset for CJT are provided as follows:

In one embodiment, UE may report inter-TRP calibration measurement if UE is configured with CSI reporting setting when ReportQuantity is indicated as inter-TRP calibration measurement reporting, e.g., ‘inter-TRP-measurement’.

In another embodiment, when UE reports inter-TRP timing difference, frequency and phase offset for CJT operation, if more than one CSI-RS resource sets or TRS resource sets are configured, UE may report CSI-RS resource set ID or TRS resource set ID for the inter-TRP calibration measurement.

In another embodiment, if one CSI-RS resource set or TRS resource set is configured, UE may report one or more CSI-RS resource ID or TRS resource ID for the inter-TRP calibration measurement.

In another embodiment, UE may report one or more CSI-RS resource ID or TRS resource ID and/or associated CSI-RS resource set ID or TRS resource set ID for inter-TRP calibration measurement.

In some embodiments, the reported CSI-RS resource ID or TRS resource ID, and/or associated CSI-RS resource set ID or TRS resource set ID may be used to indicate the reference for inter-TRP calibration measurement. In particular, this applies for the case when the UE may use different CSI-RS resources or TRS resources or a different CSI-RS resource set or a different TRS resource set to determine the reference for inter-TRP calibration measurement as long as the condition that the CSI-RS resources or TRS resources used belong to a single CSI-RS resource set or TRS resource set is met, respectively. If the UE chooses to use a different reference than indicated by the network, then it is expected to report the CSI-RS resource ID or TRS resource ID, and/or associated CSI-RS resource set ID or TRS resource set ID used to determine the reference.

In another embodiment, a bitmap may be included in the report to indicate the reference CSI-RS resource set or TRS resource set if more than one CSI-RS resource sets or TRS resource sets are configured for CJT calibration measurement. In particular, bit “1” in the bitmap may be used to indicate the reference CSI-RS resource set or TRS resource set.

In one example, if 4 CSI-RS resource sets or TRS resource sets are configured, a bitmap with size of 4 may be included in the report. If “0001” is indicated in the report, this indicates that the 4^{th} CSI-RS resource set or TRS resource set is used as reference CSI-RS resource set or TRS resource set for CJT calibration measurement.

In another embodiment, a bitmap may be included in the report to indicate the reference CSI-RS resource or TRS resource if one CSI-RS resource set or TRS resource set is configured for CJT calibration measurement, where bit “1” in the bitmap may be used to indicate the reference CSI-RS resource or TRS resource.

In another embodiment, a bitmap may be included in the report to indicate the reference CSI-RS resource or TRS resource and/or associated CSI-RS resource set or TRS resource set for CJT calibration measurement.

In another embodiment, a separate reference CSI-RS resource set or TRS resource set ID and/or reference CSI-RS resource or TRS resource ID or bitmap indication may be included in the report for each of inter-TRP delay offset, frequency offset, and phase offset.

In one example, if inter-TRP delay offset and frequency offset are configured for CJT calibration measurement, a first reference CSI-RS resource set or TRS resource set ID and/or reference CSI-RS resource or TRS resource ID may be included in the report for inter-TRP delay offset measurement, and a second reference CSI-RS resource set or TRS resource set ID and/or reference CSI-RS resource or TRS resource ID may be included in the report for inter-TRP frequency offset measurement.

In another embodiment, a bitmap may be included in the report to indicate a subset of TRPs from the configured TRPs for CJT calibration measurement. In particular, the bitmap may be included in the CSI part 1. In this case, the payload size of CSI part 2 including the CJT calibration measurement report can be determined based on the CSI part 1. Further, the inter-TRP delay offset, frequency offset and/or phase offset from the indicated subset of TRPs relative to the reference TRP may be included in the CSI part 2. In this case, the reference TRP ID or reference CSI-RS resource set or TRS resource set ID and/or reference CSI-RS resource or TRS resource ID may be determined in accordance with the indicated subset of TRPs from the configured TRPs. In one example, if 4 TRPs are configured for CJT calibration measurement and bitmap “0110” is included in the CSI part 1 report, one bit indicator may be included in the CSI part 2 report to indicate one of the two indicated subset of TRPs, i.e., TRP #1 and #2 as reference TRP. In another example, if 4 TRPs are configured for CJT calibration measurement and bitmap “0110” is included in the CSI part 1 report, reference TRP is determined as the TRP which is indicated by first bit from the bitmap equal to one (counting from the left or from the right).

In another embodiment, number of TRPs in the subset of TRPs from the configured TRPs for CJT calibration measurement may be included in the report. In particular, the number of TRPs may be included in the CSI part 1. In this case, the payload size of CSI part 2 including the CJT calibration measurement report can be determined based on the CSI part 1. Further, the subset of TRPs and the corresponding inter-TRP delay offset, frequency offset and/or phase offset from the indicated subset of TRPs relative to the reference TRP may be included in the CSI part 2. The number of TRPs may not include reference TRP.

As a further extension, if the TRPs are not included in the report for CJT calibration measurement, at least one of the measurement results for delay offset, frequency offset and/or phase offset from the TRPs relative to the reference TRP exceeds some predefined range. This is targeting for the case for TRP selection for CJT operation.

In addition, a bitmap may be included in the report to indicate whether inter-TRP delay offset, frequency offset, and phase offset may be included in the CSI report. In one example, if UE is configured to report the inter-TRP delay offset, frequency offset and phase offset may be included in the CSI report, bitmap “100” may indicate that only inter-TRP delay offset is included in the report, while inter-TRP frequency and phase offset are not included in the report. In some embodiments, the bitmap may be included in the CSI part 1.

In another embodiment, for per-TRP DL/UL Rx-Tx phase offset reporting is configured for CJT calibration reporting, an association between CSI-RS and SRS port may be defined. The association may be predefined in the specification or configured by higher layers via RRC signalling. The association between CSI-RS reception and SRS transmission may be defined in multiple ways—as an example, the same spatial domain filter is used for CSI-RS reception (for phase offset measurement) and SRS transmission. In another example, the same spatial domain reception filter is used at the UE for reception of CSI-RS from multiple TRPs for the purposes of phase-offset determination. In another example, the UE uses the same reference point (in the receive chain) for the measurement of phase-offset between the different TRPs.

In another embodiment, UE may be configured to report one or more of inter-TRP timing offset, frequency offset, and phase offset for one or more than one pairs of TRPs. In one embodiment UE may be configured to report one or more of inter-TRP timing offset, frequency offset, and phase offset of one or more TRPs as a difference with respect to a reference TRP.

In one embodiment, UE may report inter-TRP timing offset, and frequency offset for only one pair of TRPs for CJT. Further, UE may be configured to report inter-TRP phase offset for only one pair of TRPs for CJT. In this case, UE may be configured two CSI-RS resource sets or TRS resource sets for inter-TRP calibration measurement.

In another embodiment, UE may report K inter-TRP timing offsets and frequency offsets for K pairs of TRPs for CJT, where K>1. Further, UE may be configured to report K inter-TRP phase offset for K pairs of TRPs for CJT. In this case, UE may be configured (K+1) CSI-RS resource sets or TRS resource sets for inter-TRP calibration measurement.

In another embodiment, UE may report the inter-TRP calibration measurement using single CSI part, which is carried by aperiodic CSI on PUSCH.

In another embodiment, the priority of the CSI report(s) associated with inter-TRP calibration measurement is same as CSI report(s) not carrying L1-RSRP or L1-SINR.

In another embodiment, the priority of the CSI report(s) associated with inter-TRP calibration measurement is lower than CSI report(s) carrying L1-RSRP or L1-SINR, but higher than CSI report(s) not carrying L1-RSRP or L1-SINR.

In another embodiment, the priority of the CSI report(s) associated with inter-TRP calibration measurement is lower than CSI report(s) not carrying L1-RSRP or L1-SINR.

In another embodiment, when a UE is configured by higher layer parameter cjtSchemePDSCH and dl-OrJointTCI-StateList and is indicated with two TCI-States applied for PDSCH reception and reports [support for two joint TCI states for PDSCH-CJT]:
if the UE is configured with cjtSchemeC, the UE assumes that PDSCH DM-RS port(s) are QCLed with the DL RSs of the first indicated TCI-State with respect to QCL-TypeA
if the UE is configured with cjtSchemeD, the UE assumes that PDSCH DM-RS port(s) are QCLed with the DL RSs of both indicated TCI-States with respect to QCL-TypeA except for QCL parameters {Average Delay, Doppler shift, Doppler spread} of the second indicated joint TCI state.

if the UE is configured with cjtSchemeE, the UE assumes that PDSCH DM-RS port(s) are QCLed with the DL RSs of both indicated TCI-States with respect to QCL-TypeA except for QCL parameters {Average Delay, Delay spread} of the second indicated joint TCI state.
if the UE is configured with cjtSchemeF, the UE assumes that PDSCH DM-RS port(s) are QCLed with the DL RSs of both indicated TCI-States with respect to QCL-TypeA except for QCL parameters {Average Delay, Doppler shift} of the second indicated joint TCI state.

In some embodiments, support of one or more of these schemes may be based on UE capability signaling.

In some embodiments, the definition of a single TRP for the purposes of inter-TRP reporting by a UE comprises of a single TRS or a single set of CSI-RS resources. As an example, TRPs 1, 2, 3 and 4 are used for transmission of TRS 1, 2 and 3 and 4 respectively. A UE is configured to measure TRS 1, 2, 3 and 4 for inter-TRP reporting. A UE reports 3 inter-TRP measurements determined from TRS 2 with respect to TRS 1, TRS 3 with respect to TRS 1 and TRP 4 with respect to TRS 1 respectively.

In some embodiments, the definition of a single TRP for the purposes of inter-TRP reporting by a UE comprises of multiple TRSs or multiple sets of CSI-RS resources. As an example, TRPs 1, 2, 3 and 4 are used for transmission of TRS 1, 2 and 3 and 4 respectively. A UE is configured to measure TRS 1, 2, 3 and 4 for inter-TRP reporting. A UE reports one inter-TRP measurement determined from TRS 3, 4 with respect to TRS 1, 2. A UE determines such inter-TRP measurement by combining the measurements from TRS 1, 2 into an effective TRP using weights to represent the relative power between them (and similarly by combining the measurements from TRS 3, 4 into an effective TRP).

Some embodiments are directed to a user equipment (UE) operable in a 5G NR network that is configured for reference signal measurement and reporting for coherent joint transmission (CJT) from two or more transmission-reception points (TRPs). In these embodiments, the UE may decode RRC signalling with reference signal resource set configuration information for inter-TRP calibration measurements of more than one CSI-RS resource set, reporting configuration information for reporting the inter-TRP calibration measurements for the one or more than one CSI-RS resource sets, and one or more trigger states. Each trigger state may comprise a list of associated reporting configurations indicating resource set ID(s) of the configured CSI-RS resource sets. In these embodiments, the UE may decode a DCI format having a CSI request field triggering one of the one or more trigger states for the inter-TRP calibration measurement and the reporting. In response to the DCI format, in these embodiments, the UE may calculate the inter-TRP calibration measurements from CSI-RS resource sets received from the TRPs and generate a report for transmission to a gNB that includes the inter-TRP calibration measurements. In these embodiments, the report may include the resource set ID(s) of the CSI-RS resource sets associated with the inter-TRP calibration measurements. These embodiments, as well as others, are described in more detail herein.

In some embodiments, the inter-TRP calibration measurements comprise at least one of an inter-TRP timing difference measurement, an inter-TRP frequency offset measurement and an inter-TRP phase offset measurement. In these embodiments, for performing the inter-TRP calibration measurements, at least one of the CSI-RS resource sets is used a reference for the measurements. In these embodiments, the at least one CSI-RS resource set that is used as the reference for the measurements is indicated by the UE in the report by as a reference CSI-RS resource set by a reference resource set ID. In these embodiments, the reference resource set ID may be one of the resource set IDs of the CSI-RS resource sets that are configured to the UE, although that is not a requirement.

In some embodiments, the UE may select at least one CSI-RS resource set that is used as the reference for the measurements. In some embodiments, the at least one CSI-RS resource set that is used as the reference for the measurements is signaled by the gNB indicating a reference resource set ID, although the scope of the embodiments is not limited in this respect. In some embodiments, the CSI-RS resource set having a smallest ID value may be used as the reference, although the scope of the embodiments is not limited in this respect.

In some embodiments, the UE may select one CSI-RS resource set that is used as reference for each of the measurements so that the measurements result in positive values (i.e., to reduce the size of the report).

In some embodiments, the resource set configuration information for the inter-TRP calibration measurements is configured to the UE in a CSI-ResouceConfig information element (IE),

In these embodiments, the reporting configuration information is configured to the UE in a CSI-ReportConfig IE. In these embodiments, the CSI-ResourceConfig IE comprises a list of (i.e., S≥1) CSI Resource Sets (e.g., csi-RS-ResouceSetList).

In some embodiments, the CSI-RS resource sets comprise (i.e., may include) tracking reference signal (TRS) resource sets (see FIG. 2). In these embodiments, for measurement and reporting of the TRS resource sets, the processing circuitry is configured to decode a trs-info field in the CSI-ResouceConfig IE. In these embodiments, the trs-info field in the CSI-ResouceConfig IE may enable use of the TRS resource sets for measurement and reporting.

In some embodiments, after transmission of the report to the gNB, the UE may be further configured to decode a coherent joint transmission (CJT) from the two or more TRPs. In these embodiments, signals comprising the CJT having at least one of a timing difference, a frequency offset and/or a phase offset that is compensated by the gNB based on the report.

In some embodiments, the DCI format comprises one of a DCI format 0_1, a DCI format 0_2, and a DCI format 0_3. In these embodiments, for aperiodic CSI reporting, the processing circuitry is configured to decode the DCI format and check the CSI request field. In these embodiments, for aperiodic CSI reporting, CSI-RS is also triggered, and the UE measures the triggered CSI-RS and sends the A-CSI report on a PUSCH.

In some embodiments, each CSI-RS resource set is associated with a resource set ID. In these embodiments, when more than one CSI-RS resource set is configured to the UE, the UE is configured to include a reference resource set ID of the CSI-RS resource set used for the inter-TRP calibration measurements in the report. In these embodiments, the reference signal resource set ID may be used to indicate which reference signal resource set was used by the UE for the inter-TRP calibration measurement.

In some embodiments, when the report comprises more than one inter-TRP calibration measurement comprising more than one of the inter-TRP timing difference measurement and the inter-TRP frequency offset measurement, the processing circuitry is configured to include the reference resource set ID for each inter-TRP calibration measurement in the report. In these embodiments, the report may include a combination of the inter-TRP timing difference measurement and the inter-TRP frequency offset measurement. In some embodiments, a combination of the inter-TRP phase offset measurement with either the inter-TRP timing difference measurement or the inter-TRP frequency offset measurement is not included in the report.

In some embodiments, when more than one CSI-RS resource set is configured for inter-TRP calibration measurements, the processing circuitry is configured to assume: a same power control offset (e.g., powerControlOffset and/or powerControlOffsetSS) is configured for the different CSI-RS resource sets for performing the inter-TRP calibration measurements; a same periodicity for CSI-RS resources in the different CSI-RS resource sets for performing the inter-TRP calibration measurements; and a same antenna port for the CSI-RS resources in the different CSI-RS resource sets for performing the inter-TRP calibration measurements when more than one antenna port is configured for CSI-RS resources in a CSI-RS resource set.

Some embodiments are directed to a gNodeB (gNB) configured for operation in a 5G NR network. The gNB may be configured for coherent joint transmission (CJT) using two or more transmission-reception points (TRPs). In these embodiments, for reference signal measurement and reporting for the CJT by a User Equipment (UE), the gNB may encode RRC signalling (higher-layer signalling) for transmission to the UE to configure the UE with reference signal resource set configuration information (CSI-ResouceConfig) for inter-TRP calibration measurements of more than one CSI-RS resource set, reporting configuration information (CSI-ReportConfig) for reporting the inter-TRP calibration measurements for the one or more than one CSI-RS resource sets, and one or more trigger states, each trigger state comprising a list of associated CSI-ReportConfigs indicating resource set IDs of the configured CSI-RS resource sets. The gNB may encode a DCI format for transmission to the UE, the DCI format having a CSI request field triggering one of the one or more trigger states for the inter-TRP calibration measurement and the reporting. The gNB may also decode a report from the UE, the report comprising inter-TRP calibration measurements from CSI-RS resource sets received from the TRPs. In these embodiments, the report is encoded to include the resource set IDs of the CSI-RS resource sets associated with the inter-TRP calibration measurements.

In some embodiments, the inter-TRP calibration measurements comprise at least one of an inter-TRP timing difference measurement, an inter-TRP frequency offset measurement and an inter-TRP phase offset measurement. In these embodiments, at least one of the CSI-RS resource sets is used a reference by the UE for performing the inter-TRP calibration measurements. In these embodiments, the gNB may decode the report to determine which of the CSI-RS resource sets that was used as the reference for the measurements by the UE, the reference CSI-RS resource set indicated by a reference resource set ID in the report. In these embodiments, the gNB may be configured to generating signalling to cause the two or more TRPs to transmit coherent joint transmission (CJT) for reception by the UE. In these embodiments, signals comprising the CJT having at least one of a timing difference, a frequency offset and/or a phase offset that is compensated by the gNB based on the report.

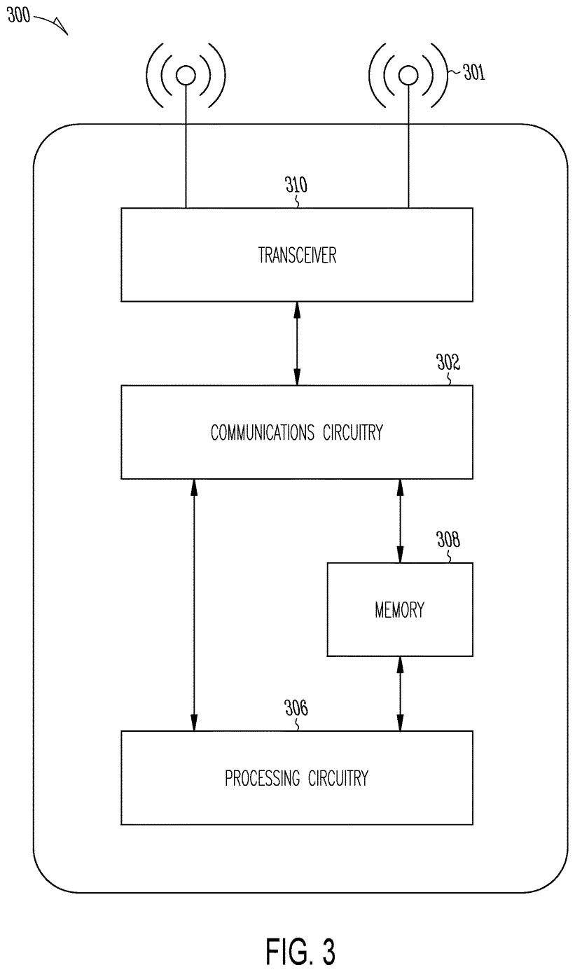

FIG. 3 illustrates a functional block diagram of a wireless communication device, in accordance with some embodiments. Wireless communication device 300 may be suitable for use as a UE or gNB configured for operation in a 5G NR or 6G network. Some embodiments are directed to an apparatus of a UE or gNB comprising processing circuitry and memory configured for operation in a 5G NR or 6G network.

The wireless communication device 300 may include communications circuitry 302 and a transceiver 310 for transmitting and receiving signals to and from other communication devices using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The wireless communication device 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In accordance with some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the wireless communication device 300 may include one or more processors. In other embodiments, two or more antennas 301 may be coupled to the communications circuitry 302 arranged for sending and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the wireless communication device 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 300 may include one or more of a keyboard, a display, a non-volatile memory port, multiple antennas, a graphics processor, an application processor, speakers, and other mobile device elements. The display may be an LCD screen including a touch screen.

Although the wireless communication device 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 300 may refer to one or more processes operating on one or more processing elements.

Some embodiments are directed to an apparatus of a UE. Some embodiments are directed to an apparatus of a gNB, and some embodiments are directed to a non-transitory computer-readable storage medium.

In some embodiments, the procedures on aperiodic CSI reporting assume that the CSI reporting is triggered by DCI format 0_1, but they equally apply to CSI reporting triggered by DCI format 0_2, by applying the higher layer parameter reportTriggerSizeDCI-0-2 instead of reportTriggerSize. The procedures on aperiodic CSI reporting assume that the CSI reporting is triggered by DCI format 0_1, but they equally apply to CSI reporting triggered by DCI format 0_3.

The time and frequency resources that can be used by the UE to report CSI are controlled by the gNB. CSI may consist of Channel Quality Indicator (CQI), precoding matrix indicator (PMI), CSI-RS resource indicator (CRI), SS/PBCH Block Resource indicator (SSBRI), layer indicator (LI), rank indicator (RI), L1-RSRP, L1-SINR, CapabilityIndex or time-domain channel properties (TDCP).

For CQI, PMI, CRI, SSBRI, LI, RI, L1-RSRP, L1-SINR, CapabilityIndex, TDCP a UE is configured by higher layers with N≥1 CSI-ReportConfig Reporting Settings and/or X≥1 LTM-CSI-ReportConfig Reporting Settings, M≥1 CSI-ResourceConfig Resource Settings and/or Y≥1 LTM-CSI-ResourceConfig Resource Settings, and one or two list(s) of trigger states (given by the higher layer parameters CSI-Aperiodic TriggerStateList and CSI-SemiPersistentOnPUSCH-TriggerStateList). Each trigger state in CSI-Aperiodic Trigger StateList contains a list of associated CSI-ReportConfigs or LTM-CSI-ReportConfigs indicating the Resource Set IDs for channel and optionally for interference where a Resource Set for interference can only be present for a Report Setting given by a CSI-ReportConfig and a trigger state additionally contains one or more CSI-ReportSubConfigId if the associated CSI-ReportConfig configured with a list of sub-configurations. Each trigger state in CSI-SemiPersistentOnPUSCH-TriggerStateList contains one associated CSI-ReportConfig or LTM-CSI-ReportConfig, and a trigger state additionally contain one or more CSI-ReportSubConfigId if the associated CSI-ReportConfig is configured with a list of sub-configurations.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, SSBRI (SSB Resource Indicator), CapabilityIndex and TDCP.

Each Reporting Setting LTM-CSI-ReportConfig is associated with an LTM-CSI-ResourceConfig for channel measurement and contains the parameters(s) for time-domain behavior provided by ltm-ReportConfigType, the number of cells and the number of reference signals per candidate cell provided by nrOfReportedCells, and nrOfReportedRS-PerCell, respectively, comprising L1 measurement results associated with current SpCell if spCellInclusion is configured.

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, L1-SINR-related, CapabilityIndex-related or TDCP-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II, Enhanced Type II CSI, Further Enhanced Type II Port Selection, Enhanced Type II for coherent joint transmission (CJT), Further Enhanced Type II Port Selection for CJT, Enhanced Type II for predicted PMI, or Further Enhanced Type II Port Selection for predicted PMI including codebook subset restriction when applicable, and configurations of group-based reporting. A UE is not expected to be configured with a CSI report setting associated with a dormant DL BWP if the reportConfigType is set to ‘aperiodic’. A CSI-ReportConfig can contain a list of sub-configurations, provided by the higher layer parameter csi-ReportSubConfigToAddModList, where each sub-configuration is identified by CSI-ReportSubConfigId and configured with nzp-CSI-RS-ResourceList which corresponds to a list of one or more CSI-RS resources or configured with portSubsetIndicator which corresponds to a CSI-RS antenna port subset, and/or configured with powerOffset which corresponds to a power offset for PDSCH relative to CSI-RS additional to powerControlOffset of the CSI-RS resource(s). A UE is not expected to be configured with a CSI-ReportConfig that contains a mix of sub-configuration(s) each configured with nzp-CSI-RS-ResourceList which corresponds to a list of one or more CSI-RS resources and some other sub-configuration(s) each configured with portSubsetIndicator which corresponds to CSI-RS antenna port subset.

The time domain behavior of LTM-CSI-ReportConfig is indicated by the higher layer parameter ltm-ReportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on.

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-IM resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resource Type and can be set to aperiodic, periodic, or semi-persistent. For periodic and semi-persistent CSI Resource Settings, when the UE is configured with groupBasedBeamReporting-r17 or groupBasedBeamReporting-v18, the number of CSI Resource Sets configured is S=2, otherwise the number of CSI-RS Resource Sets configured is limited to S=1, except for periodic CSI Resource Settings, when the UE is configured with TDCP reporting, for which the number of CSI-RS Resource Sets in the CSI Resource Setting for channel measurement is K_{TRS}€{1,2,3} and all the CSI-RS Resource Sets are configured with the higher layer parameter trs-Info. For periodic and semi-persistent CSI Resource Settings, the configured periodicity and slot offset is given in the numerology of its associated DL BWP, as given by BWP-id. When a UE is configured with multiple CSI-ResourceConfigs consisting of the same NZP CSI-RS resource ID, the same time domain behavior shall be configured for the CSI-ResourceConfigs. When a UE is configured with multiple CSI-ResourceConfigs consisting of the same CSI-IM resource ID, the same time-domain behavior shall be configured for the CSI-ResourceConfigs. All CSI Resource Settings linked to a CSI Report Setting shall have the same time domain behavior.

The following are configured via higher layer signaling for one or more CSI Resource Settings for channel and interference measurement:
CSI-IM resource for interference measurement.
NZP CSI-RS resource for interference measurement.
NZP CSI-RS resource for channel measurement as described.

The UE may assume that the NZP CSI-RS resource(s) for channel measurement and the CSI-IM resource(s) for interference measurement configured for one CSI reporting are resource-wise QCLed with respect to ‘typeD’. When NZP CSI-RS resource(s) is used for interference measurement, the UE may assume that the NZP CSI-RS resource for channel measurement and the CSI-IM resource or NZP CSI-RS resource(s) for interference measurement configured for one CSI reporting are QCLed with respect to ‘typeD’. For TDCP measurement, one periodic CSI Resource Setting is configured, and the Resource Setting is for channel measurement on CSI-RS for tracking.

### EXAMPLES

1. A system and method of wireless communication for a fifth generation (5G) or new radio (NR) system:
Configured, by gNodeB, one or more channel state information reference signal (CSI-RS) resource sets or tracking reference signal (TRS) resource sets for calibration measurement between transmit receive point (TRP) for coherent joint transmission (CJT).
Reported, by UE, inter-TRP calibration measurement in physical uplink shared channel (PUSCH) to the gNB.
2. The system and method of example 1, wherein the inter-TRP calibration measurement includes one or more of inter-TRP timing difference, frequency offset, and phase offset.
3. The system and method of example 1, wherein when more than one CSI-RS resource sets or TRS resource sets are configured for inter-TRP calibration measurement, the number of CSI-RS resources or TRS resources in the CSI-RS resource sets or TRS resource sets is same
4. The system and method of example 1, wherein same resource type configurations, including periodic, semi-persistent and aperiodic CSI-RS resource or TRS resources for different CSI-RS resource sets or TRS resource sets are configured for inter-TRP calibration measurement
5. The system and method of example 1, wherein UE may assume that CSI-RS resources or TRS resources in different CSI-RS resource sets or TRS resource sets are configured with same bandwidth and subcarrier locations
6. The system and method of example 1, wherein gNB may indicate a CSI-RS resource set ID or TRS resource set ID as a reference for inter-TRP calibration measurement.
7. The system and method of example 1, wherein gNB may indicate one or more CSI-RS resource IDs or TRS resource IDs and/or corresponding CSI-RS resource set ID or TRS resource set ID as reference for inter-TRP calibration measurement.
8. The system and method of example 1, wherein inter-TRP timing difference can be defined as the DL relative timing difference between the Transmission Point (TP) j and the reference TP i, which can be given by T_{SubframeRxj}−T_{SubframeRxi}, where T_{SubframeRxj} is the time when the UE receives the start of one subframe from TP j, and T_{SubframeRxi} is the time when the UE receives the corresponding start of one subframe from TP I that is closest in time to the subframe received from TP j.
9. The system and method of example 1, wherein for inter-TRP timing difference measurement, the reporting range may be defined as [−N·T_{c}, N·T_{c}] with resolution step of 2^{K}·T_{c}, where T_{c} is the minimum timing duration; N is an integer that is predefined in the specification or configured by higher layers via NR remaining minimum system information (RMSI), NR other system information (OSI) or dedicated radio resource control (RRC) signalling, K is an integer,
10. The system and method of example 1, wherein for inter-TRP frequency offset measurement, the reporting range may be defined as [−Δfₘₐₓ, Δfₘₐₓ] with resolution step of Δfₛₜₑₚ, where Δfₘₐₓ and Δfₛₜₑₚ can be predefined in the specification or configured by higher layers via RMSI, OSI, or RRC signalling
11. The system and method of example 1, wherein for inter-TRP phase offset measurement, the reported value can be defined as k, where k={0, 1, . . . , Nₚ−1}, and Nₚ is a predetermined in the specification or configured by higher layers via RMSI, OSI, or RRC signalling.
12. The system and method of example 1, wherein for inter-TRP timing difference and/or inter-TRP frequency offset and/or inter-TRP phase offset, if receiver diversity is in use by the UE, the reported value shall be no lower than the minimum and no higher than the maximum measured values across the receiver branches.
13. The system and method of example 1, wherein UE may report inter-TRP calibration measurement if UE is configured with CSI reporting setting when ReportQuantity is indicated as inter-TRP calibration measurement reporting, e.g., ‘inter-TRP-measurement’.
14. The system and method of example 1, wherein when UE reports inter-TRP timing difference, frequency and phase offset for CJT operation, if more than one CSI-RS resource sets or TRS resource sets are configured, UE may report CSI-RS resource set ID or TRS resource set ID for the inter-TRP calibration measurement.
15. The system and method of example 1, wherein UE may report one or more CSI-RS resource ID or TRS resource ID and/or associated CSI-RS resource set ID or TRS resource set ID for inter-TRP calibration measurement.
16. The system and method of example 1, wherein UE may be configured to report one or more of inter-TRP timing offset, frequency offset, and phase offset for one or more than one pairs of TRPs.
17. The system and method of example 1, wherein UE may report the inter-TRP calibration measurement using single CSI part, which is carried by aperiodic CSI on PUSCH.
18. The system and method of example 1, wherein the priority of the CSI report(s) associated with inter-TRP calibration measurement is same as CSI report(s) not carrying L1-RSRP or L1-SINR.
19. The system and method of example 1, wherein a bitmap may be included in the report to indicate the reference CSI-RS resource set or TRS resource set if more than one CSI-RS resource sets or TRS resource sets are configured for CJT calibration measurement.
20. The system and method of example 1, wherein a bitmap may be included in the report to indicate the reference CSI-RS resource or TRS resource if one CSI-RS resource set or TRS resource set is configured for CJT calibration measurement, where bit “1” in the bitmap may be used to indicate the reference CSI-RS resource or TRS resource.
21. The system and method of example 1, wherein a bitmap may be included in the report to indicate the reference CSI-RS resource or TRS resource and/or associated CSI-RS resource set or TRS resource set for CJT calibration measurement.
22. The system and method of example 1, wherein a separate reference CSI-RS resource set or TRS resource set ID and/or reference CSI-RS resource or TRS resource ID or bitmap indication may be included in the report for each of inter-TRP delay offset, frequency offset, and phase offset
23. The system and method of example 1, wherein a bitmap may be included in the report to indicate a subset of TRPs from the configured TRPs for CJT calibration measurement.
24. The system and method of example 1, wherein a bitmap may be included in the report to indicate whether inter-TRP delay offset, frequency offset, and phase offset may be included in the CSI report.
25. The system and method of example 1, wherein for per-TRP DL/UL Rx-Tx phase offset reporting is configured for CJT calibration reporting, an association between CSI-RS and SRS port may be defined, wherein the association may be predefined in the specification or configured by higher layers via RRC signalling.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for a user equipment (UE) configured for operation in a 5G NR network, the apparatus comprising: processing circuitry; and memory, wherein for reference signal measurement and reporting for coherent joint transmission (CJT) from two or more transmission-reception points (TRPs), the processing circuitry is configured to:
decode RRC signalling to configure the UE with:
resource set configuration information for inter-TRP calibration measurements of more than one CSI-RS resource set;
reporting configuration information for reporting the inter-TRP calibration measurements for the one or more than one CSI-RS resource sets; and
one or more trigger states, each trigger state comprising a list of associated reporting configurations indicating resource set IDs of the configured CSI-RS resource sets,
decode a DCI format having a CSI request field triggering one of the one or more trigger states for the inter-TRP calibration measurement and the reporting; and
in response to the DCI format:
calculate the inter-TRP calibration measurements from CSI-RS resource sets received from the TRPs; and
generate a report for transmission to a gNB, the report comprising the inter-TRP calibration measurements,
wherein the report is encoded to include the resource set IDs of the CSI-RS resource sets associated with the inter-TRP calibration measurements.

2. The apparatus of claim 1, wherein the inter-TRP calibration measurements comprise at least one of an inter-TRP timing difference measurement, an inter-TRP frequency offset measurement and an inter-TRP phase offset measurement,
wherein for performing the inter-TRP calibration measurements, at least one of the CSI-RS resource sets is used a reference for the measurements, and
wherein the at least one CSI-RS resource set that is used as the reference for the measurements is indicated by the UE in the report by as a reference CSI-RS resource set by a reference resource set ID.

3. The apparatus of claim 2, wherein the processing circuitry is configured to select at least one CSI-RS resource set that is used as the reference for the measurements.

4. The apparatus of claim 3, wherein the processing circuitry is configured to select one CSI-RS resource set that is used as reference for each of the measurements so that the measurements result in positive values.

5. The apparatus of claim 3, wherein the resource set configuration information for the inter-TRP calibration measurements is configured to the UE in a CSI-ResouceConfig information element (IE),
wherein the reporting configuration information is configured to the UE in a CSI-ReportConfig IE, and
wherein the CSI-ResourceConfig IE comprises a list of CSI Resource Sets.

6. The apparatus of claim 5, wherein the CSI-RS resource sets comprise tracking reference signal (TRS) resource sets,
wherein for measurement and reporting of the TRS resource sets, the processing circuitry is configured to decode a trs-info field in the CSI-ResouceConfig IE.

7. The apparatus of claim 5, wherein after transmission of the report to the gNB, the processing circuitry is further configured to decode a coherent joint transmission (CJT) from the two or more TRPs, and
wherein signals comprising the CJT having at least one of a timing difference, a frequency offset and/or a phase offset that is compensated by the gNB based on the report.

8. The apparatus of claim 5, wherein the DCI format comprises one of a DCI format 0_1, a DCI format 0_2, and a DCI format 0_3, and
wherein for aperiodic CSI reporting, the processing circuitry is configured to decode the DCI format and check the CSI request field.

9. The apparatus of claim 5 wherein each CSI-RS resource set is associated with a resource set ID, and
wherein when more than one CSI-RS resource set is configured to the UE, the UE is configured to include a reference resource set ID of the CSI-RS resource set used for the inter-TRP calibration measurements in the report.

10. The apparatus of claim 9, wherein when the report comprises more than one inter-TRP calibration measurement comprising more than one of the inter-TRP timing difference measurement and the inter-TRP frequency offset measurement, the processing circuitry is configured to include the reference resource set ID for each inter-TRP calibration measurement in the report.

11. The apparatus of claim 2, wherein when more than one CSI-RS resource set is configured for inter-TRP calibration measurements, the processing circuitry is configured to assume:
a same power control offset is configured for the CSI-RS resource sets for performing the inter-TRP calibration measurements;
a same periodicity for CSI-RS resources in the CSI-RS resource sets for performing the inter-TRP calibration measurements; and
a same antenna port for the CSI-RS resources in the different CSI-RS resource sets for performing the inter-TRP calibration measurements when more than one antenna port is configured for CSI-RS resources in a CSI-RS resource set.

12. A non-transitory computer-readable storage medium that stores instructions for execution by processing circuitry of a user equipment (UE) configured for operation in a 5G NR network, wherein for reference signal measurement and reporting for coherent joint transmission (CJT) from two or more transmission-reception points (TRPs), the processing circuitry is configured to:
decode RRC signalling to configure the UE with:
resource set configuration information for inter-TRP calibration measurements of more than one CSI-RS resource set;
reporting configuration information for reporting the inter-TRP calibration measurements for the one or more than one CSI-RS resource sets; and
one or more trigger states, each trigger state comprising a list of associated reporting configurations indicating resource set IDs of the configured CSI-RS resource sets,
decode a DCI format having a CSI request field triggering one of the one or more trigger states for the inter-TRP calibration measurement and the reporting; and
in response to the DCI format:
calculate the inter-TRP calibration measurements from CSI-RS resource sets received from the TRPs; and
generate a report for transmission to a gNB, the report comprising the inter-TRP calibration measurements,
wherein the report is encoded to include the resource set IDs of the CSI-RS resource sets associated with the inter-TRP calibration measurements.

13. The non-transitory computer-readable storage medium of claim 12, wherein the inter-TRP calibration measurements comprise at least one of an inter-TRP timing difference measurement, an inter-TRP frequency offset measurement and an inter-TRP phase offset measurement,
wherein for performing the inter-TRP calibration measurements, at least one of the CSI-RS resource sets is used a reference for the measurements, and
wherein the at least one CSI-RS resource set that is used as the reference for the measurements is indicated by the UE in the report by as a reference CSI-RS resource set by a reference resource set ID.

14. The non-transitory computer-readable storage medium of claim 13, wherein the processing circuitry is configured to select at least one CSI-RS resource set that is used as the reference for the measurements.

15. The non-transitory computer-readable storage medium of claim 14, wherein the processing circuitry is configured to select one CSI-RS resource set that is used as reference for each of the measurements so that the measurements result in positive values.

16. The non-transitory computer-readable storage medium of claim 14, wherein the resource set configuration information for the inter-TRP calibration measurements is configured to the UE in a CSI-ResouceConfig information element (IE),
wherein the reporting configuration information is configured to the UE in a CSI-ReportConfig IE, and
wherein the CSI-ResourceConfig IE comprises a list of CSI Resource Sets.

17. The non-transitory computer-readable storage medium of claim 16, wherein the CSI-RS resource sets comprise tracking reference signal (TRS) resource sets,
wherein for measurement and reporting of the TRS resource sets, the processing circuitry is configured to decode a trs-info field in the CSI-ResouceConfig IE.

18. An apparatus for a gNodeB (gNB) configured for operation in a 5G NR network, the apparatus comprising: processing circuitry; and memory, the gNB configured for coherent joint transmission (CJT) using two or more transmission-reception points (TRPs),
wherein for reference signal measurement and reporting for the CJT by a User Equipment (UE), the processing circuitry is configured to:
encode RRC signalling (higher-layer signalling) for transmission to the UE to configure the UE with:
resource set configuration information for inter-TRP calibration measurements of more than one CSI-RS resource set;
reporting configuration information for reporting the inter-TRP calibration measurements for the one or more than one CSI-RS resource sets; and
one or more trigger states, each trigger state comprising a list of associated CSI-ReportConfigs indicating resource set IDs of the configured CSI-RS resource sets,
encode a DCI format for transmission to the UE, the DCI format having a CSI request field triggering one of the one or more trigger states for the inter-TRP calibration measurement and the reporting; and
decode a report from the UE, the report comprising inter-TRP calibration measurements from CSI-RS resource sets received from the TRPs,
wherein the report is encoded to include the resource set IDs of the CSI-RS resource sets associated with the inter-TRP calibration measurements.

19. The apparatus of claim 18, wherein the inter-TRP calibration measurements comprise at least one of an inter-TRP timing difference measurement, an inter-TRP frequency offset measurement and an inter-TRP phase offset measurement,
wherein at least one of the CSI-RS resource sets is used a reference by the UE for performing the inter-TRP calibration measurements, and
wherein the processing circuitry is configured to decode the report to determine which of the CSI-RS resource sets that was used as the reference for the measurements by the UE, the reference CSI-RS resource set indicated by a reference resource set ID in the report.

20. The apparatus of claim 19, the processing circuitry is configured to generating signalling to cause the two or more TRPs to transmit coherent joint transmission (CJT) for reception by the UE,
wherein signals comprising the CJT having at least one of a timing difference, a frequency offset and/or a phase offset that is compensated by the gNB based on the report.
